(19) United States
(12) Patent Application Publication
(10) Pub. No.: US 2023/0140005 A1
(43) Pub. Date: May 4, 2023

(54) SYSTEM AND METHOD FOR DISTRIBUTING SATELLITE-BASED INTERNET SERVICES AND CONDUCTING REMOTE OPERATIONS USING THE SAME

(71) Applicants: Peter Coker, Dover, DE (US); Clayton Turner, Lacey, WA (US)

(72) Inventors: Peter Coker, Dover, DE (US); Clayton Turner, Lacey, WA (US)

(21) Appl. No.: 17/978,362

(22) Filed: Nov. 1, 2022

Related U.S. Application Data
(60) Provisional application No. 63/274,434, filed on Nov. 1, 2021.

(51) Int. Cl. H04B 7/185

(52) U.S. Cl. CPC H04B 7/18519; H04B 7/1855; H04B 7/18523

(57) ABSTRACT

A system for conducting remote operations including a plurality of vehicles, a plurality of relay stations, one or more of which are configured to provide power to the vehicles, and a plurality of containers at the configured relay stations and configured for transport by the vehicles, wherein the vehicles, stations, and containers maintain a connection to a communication network through which they communicate with one another and with other devices connected to the network, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network, and each container includes apparatus for use in a respective activity needed to complete one or more of the remote operations.

### FIELD OF THE INVENTION

The present general inventive concept relates generally to providing Internet access and remote services, and more particularly to distributing satellite-based Internet services and conducting remote operations using the same.

### CROSS-REFERENCE TO RELATED APPLICATION

The present invention claims priority from the following U.S. Provisional Application, the entire disclosure of which, including but not limited to any and all cited references, is incorporated herein by reference: U.S. Provisional Application No. 63/274,434 (filed Nov. 1, 2021).

### BACKGROUND OF THE INVENTION

There have been previous means for providing Internet access and remote services. For example, it has been possible to obtain Internet access that is landline-based, cellular-based, and satellite-based, and it has been possible to provide remote services by airplane and helicopter.

However, landline-based Internet access is expensive to provide to remote areas, due to the amount of fiber-optic cable needed, and the manpower to place the cables underground or underwater, and protect them from the elements and sabotage.

Similarly, cellular-based Internet access is expensive to provide to remote areas, due to the amount of towers needed, and the manpower to install the towers on land and sea, and protect them from the elements and sabotage.

While satellite-based Internet access can be obtained in remote areas, the receiver hardware is bulky and heavy, and expensive for the average person.

Finally, even if Internet access can be provided in remote areas, transporting apparatus and personnel to remote areas to provide assistance is extremely expensive, primarily due to the costs associated with dispatching and operating airplanes and helicopters.

Therefore, what is needed is a system for providing Internet access and remote services that does not suffer from the aforementioned shortcomings.

### SUMMARY OF THE INVENTION

Problems associated with prior systems are readily addressed according to the present general inventive concept by providing a system and method for distributing satellite-based Internet services and conducting remote operations using the same.

### Systems

More particularly, the present invention provides a system for conducting remote operations, comprising: a plurality of vehicles; a plurality of relay stations, one or more of which are configured to provide power to the vehicles; and a plurality of containers at the configured relay stations and configured for transport by the vehicles. In preferred embodiments, the vehicles, stations, and containers maintain a connection to a communication network through which they communicate with one another and with other devices connected to the network. In preferred embodiments, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network. In preferred embodiments, each container includes apparatus for use in a respective activity needed to complete one or more of the remote operations.

In preferred embodiments, the activity is one or more of providing sustenance, providing shelter, providing medical care, alerting an emergency responder, providing rescue, providing protection, repelling an attack, launching an attack, fighting a natural disaster, delivering an item, and providing a service.

In preferred embodiments, the plurality of vehicles includes one or more of an aerial drone, a land drone, a water drone, a manned drone, an unmanned drone, a remotely piloted drone, a computer-piloted drone, and an autonomous drone.

Preferably, in these and other embodiments, each of one or more of the vehicles makes the communication network available to one or more third party devices in proximity to the vehicle.

Further preferably, in these and other embodiments, at least two of the vehicles maintain a communication pathway from one of the relay stations through a first of the at least two of the vehicles and through to a second of the at least two of the vehicles, the second of the at least two of the vehicles making the communication network available through the communication pathway to one of the third party devices, the one of the third party devices being in a remote area in proximity to the second of the at least two of the vehicles.

In preferred embodiments, each relay station is configured to obtain an Internet connection from one or more of a satellite signal, a cellular signal, and a wired connection, and make the Internet connection available through the communication network via one or more of a cellular signal, a Wi-Fi signal, a Bluetooth signal, and a wired connection.

Preferably, in these and other embodiments, each relay station is further configured to obtain power from one or more of a solar panel, a wind energy generator, a movement energy generator, a wave energy generator, a geothermal energy generator, a nuclear power generator, an electrical power source, and a battery.

Further preferably, in these and other embodiments, at least one relay station is further configured to make at least a portion of the obtained power available through a port on the relay station.

Further preferably, in these and other embodiments, each of the relay stations configured to provide power to the vehicles includes at least one port at which each of the vehicles can dock, and is further configured to provide at least a portion of the obtained power at the at least one port to any one of the vehicles when docked at the at least one port.

Further preferably, in these and other embodiments, at least one of the Internet connection and the portion of the obtained power is made available based on one or more commercial transactions.

### Methods

Further particularly, the present invention provides a method for conducting remote operations, comprising: providing a plurality of vehicles; providing a plurality of relay stations, one or more of which are configured to provide power to the vehicles; and providing a plurality of containers at the configured relay stations and configured for transport by the vehicles. In preferred embodiments, the vehicles, stations, and containers maintain a connection to a communication network through which they communicate with one another and with other devices connected to the network. In preferred embodiments, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network. In preferred embodiments, each container includes apparatus for use in a respective activity needed to complete one or more of the remote operations.

In preferred embodiments, the activity is one or more of providing sustenance, providing shelter, providing medical care, alerting an emergency responder, providing rescue, providing protection, repelling an attack, launching an attack, fighting a natural disaster, delivering an item, and providing a service.

In preferred embodiments, the plurality of vehicles includes one or more of an aerial drone, a land drone, a water drone, a manned drone, an unmanned drone, a remotely piloted drone, a computer-piloted drone, and an autonomous drone.

Preferably, in these and other embodiments, each of one or more of the vehicles makes the communication network available to one or more third party devices in proximity to the vehicle.

Further preferably, in these and other embodiments, at least two of the vehicles maintain a communication pathway from one of the relay stations through a first of the at least two of the vehicles and through to a second of the at least two of the vehicles, the second of the at least two of the vehicles making the communication network available through the communication pathway to one of the third party devices, the one of the third party devices being in a remote area in proximity to the second of the at least two of the vehicles.

In preferred embodiments, each relay station is configured to obtain an Internet connection from one or more of a satellite signal, a cellular signal, and a wired connection, and make the Internet connection available through the communication network via one or more of a cellular signal, a Wi-Fi signal, a Bluetooth signal, and a wired connection.

Preferably, in these and other embodiments, each relay station is further configured to obtain power from one or more of a solar panel, a wind energy generator, a movement energy generator, a wave energy generator, a geothermal energy generator, a nuclear power generator, an electrical power source, and a battery.

Further preferably, in these and other embodiments, at least one relay station is further configured to make at least a portion of the obtained power available through a port on the relay station.

Further preferably, in these and other embodiments, each of the relay stations configured to provide power to the vehicles includes at least one port at which each of the vehicles can dock, and is further configured to provide at least a portion of the obtained power at the at least one port to any one of the vehicles when docked at the at least one port.

Further preferably, in these and other embodiments, at least one of the Internet connection and the portion of the obtained power is made available based on one or more commercial transactions.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates an exemplary vehicle of the present invention

FIG. 2 illustrates a preferred embodiment of the present invention in which a plurality of exemplary relay stations of the present invention are positioned at various respective locations on Earth.

FIG. 3 illustrates a schematic diagram of an exemplary relay station 200 of the present invention.

FIG. 4 illustrates an exemplary water-based relay station having components illustrated in FIG. 3.

FIGS. 5-6 illustrate exemplary land-based relay stations having components illustrated in FIG. 3.

FIGS. 7-11 illustrate preferred use cases of the present invention.

FIG. 12 illustrates a preferred embodiment of a method of the present invention.

### DESCRIPTION OF PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The following description is provided to assist the reader in gaining a comprehensive understanding of the systems and methods described herein. Accordingly, various changes, modifications, and equivalents of the systems and methods described herein will be suggested to those of ordinary skill in the art. The progression of method operations described are merely examples, however, and the sequence of operations is not limited to that set forth herein and may be changed as is known in the art, with the exception of operations necessarily occurring in a certain order. Also, descriptions of well-known functions and methods may be simplified and/or omitted for increased clarity and conciseness.

Numerous variations, modifications, and additional embodiments are possible, and accordingly, all such variations, modifications, and embodiments are to be regarded as being within the spirit and scope of the present invention. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity may be repeated, any activity may be performed by multiple entities, and/or any element may be duplicated.

Certain of the foregoing and related aspects are readily attained according to the present general inventive concept by providing a system and method for distributing satellite-based Internet services and conducting remote operations using the same.

As used herein, the term “remote” can refer to, in addition to any other understood meanings, being or taking place in an area in which communication or transportation, whether to, from, or within the area, is non-existent or burdensome. Exemplary remote locations include without limitation such areas in deserts, wilderness, mountains, central areas of large bodies of water, sparsely inhabited regions, regions inhabited by indigent populations, and regions with populations lacking modern technology or an understanding of its use.

### Systems and Methods

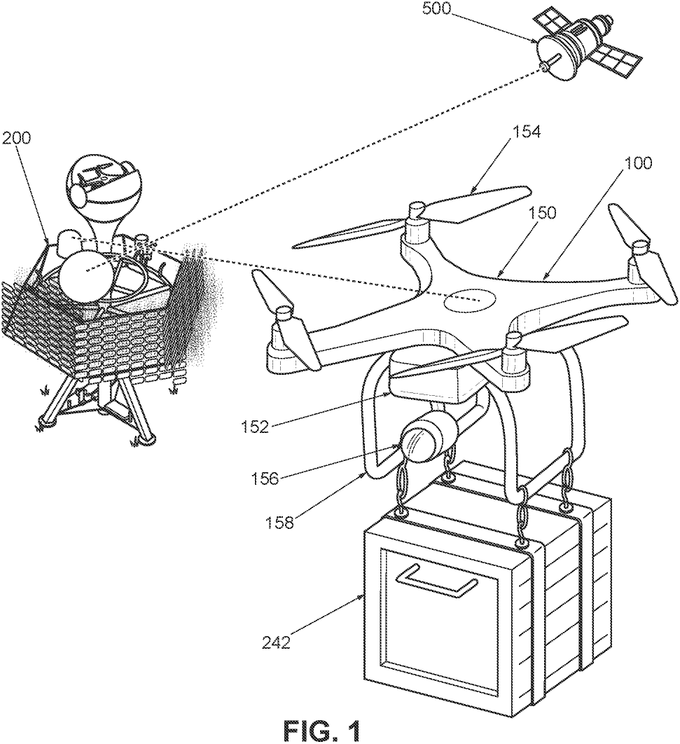

Preferred embodiments of the present invention will be described in detail with reference to elements illustrated in FIGS. 1-12, and additional and/or alternative elements will be described as additional or alternative elements of the preferred embodiments and/or as elements of other embodiments. It should be understood that various embodiments of the present invention can include none or any number of any described element or step, and any permutation of described elements or steps.

As discussed above, the present invention provides a system for conducting remote operations, comprising: a plurality of vehicles; a plurality of relay stations, one or more of which are configured to provide power to the vehicles; and a plurality of containers at the configured relay stations and configured for transport by the vehicles. In preferred embodiments, the vehicles, stations, and containers maintain a connection to a communication network through which they communicate with one another and with other devices connected to the network. In preferred embodiments, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network. In preferred embodiments, each container includes apparatus for use in a respective activity needed to complete one or more of the remote operations.

These and other aspects of the present invention will be described in detail below.

### Vehicles

With regard to the plurality of vehicles, FIG. 1 illustrates an exemplary vehicle 100 of the present invention. In preferred embodiments of the present invention, the aforementioned plurality of vehicles includes one or more of an aerial drone, a land drone, a water drone, a manned drone, an unmanned drone, a remotely piloted drone, a computer-piloted drone, and an autonomous drone. In the illustrated embodiment, the vehicle 100 is an aerial drone.

In preferred embodiments of the present invention, a plurality of vehicles 100 are used in a system of the present invention. The vehicles used can be of the same type, or can be of a plurality of different types, in any combination or permutation. Different types of vehicles may have different capabilities and be more efficient for certain operations. Accordingly, the vehicles can be chosen based on operational needs and intended uses.

The illustrated drone 100 includes a drone body 150, a power source including a battery 152, a propulsion system including propellors 154, a camera 156 and a container transport system 158. While not shown, the illustrated drone 100 further includes a processor, a circuit, a memory, a modem, an antenna, and a router in operative communication with one another and with the other components. While not shown, the illustrated drone 100 further includes a global positioning system (GPS) for knowing and determining its position and positions of other GPS equipped devices in real space, and determining directions and lines of travel to travel from one position to another.

In preferred embodiments of the present invention, each vehicle of the present invention can communicate with the relay stations of the present invention. FIG. 1 illustrates the drone 100 wirelessly communicating with an exemplary relay station 200. Such aspects of the present invention will be described in greater detail below.

### Relay Stations

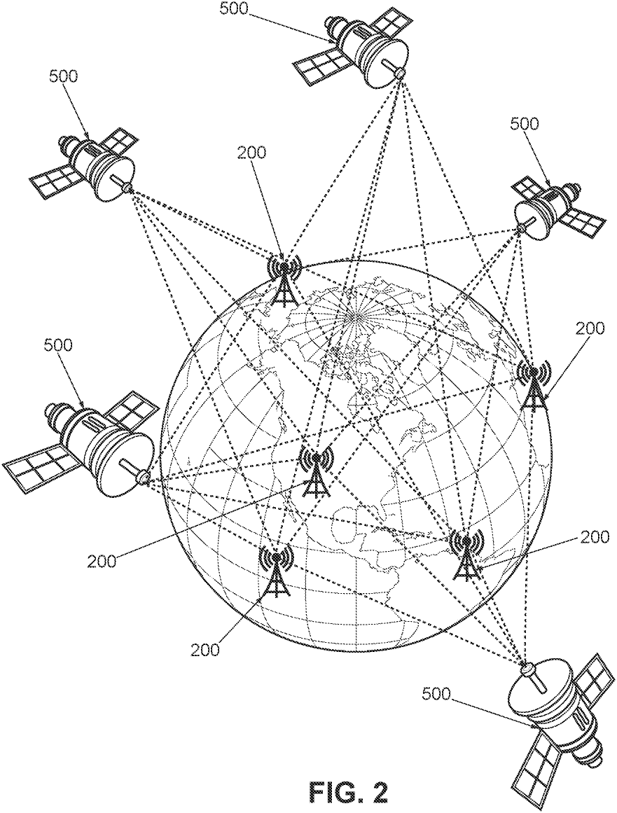

With regard to the plurality of relay stations, FIG. 2 illustrates a preferred embodiment of the present invention in which a plurality of exemplary relay stations 200 of the present invention are positioned at various respective locations on Earth. While any desired arrangement of relay stations is contemplated by the present invention, a preferred arrangement of the relay stations is one in which the relay stations are located in or near remote areas. FIG. 2 illustrates relay stations 200 being located on land and on water, at various remote locations.

FIG. 2 further illustrates a constellation of satellites 500 and radio wave carriers 510 being transmitted to and from the satellites 500 and the relay stations 200. These aspects of the present invention will be described in greater detail below.

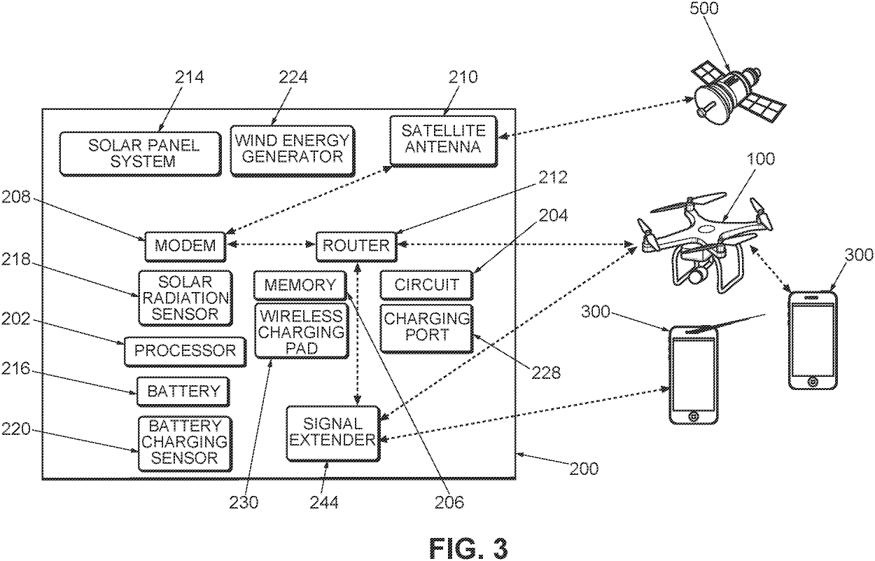

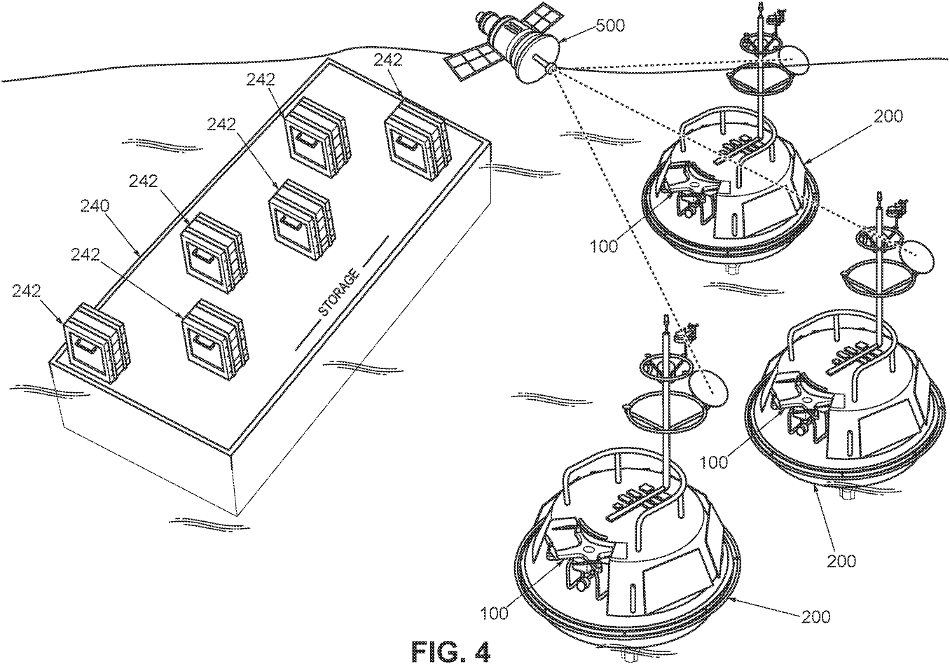

FIG. 3 illustrates a schematic diagram of an exemplary relay station 200 of the present invention. The components of the relay station 200 and their functionality will be described in detail, in connection with the schematic diagram of FIG. 3 as well as with the exemplary relay stations illustrated in FIGS. 4-6. References to element 200 refer also to elements 200A and 200B unless otherwise specifically indicated.

In preferred embodiments of the present invention, the relay stations are preferably comprised of renewable materials, such as, for example, hydrophobic carbon compounds. The use of renewable materials reduces waste by using recyclable and recycled materials. However, as can be appreciated, the relay stations may be comprised of any materials suitable for the structures and operations described herein.

With regard to certain relay stations being located on water, FIG. 4 illustrates an exemplary water-based relay station 200 having components illustrated in FIG. 3. The illustrated water-based relay station 200 is configured for deployment in any body of water. For example, the various components of the water-based relay station 200 are individually, or via an enclosure, configured for buoyancy and protection from water environments.

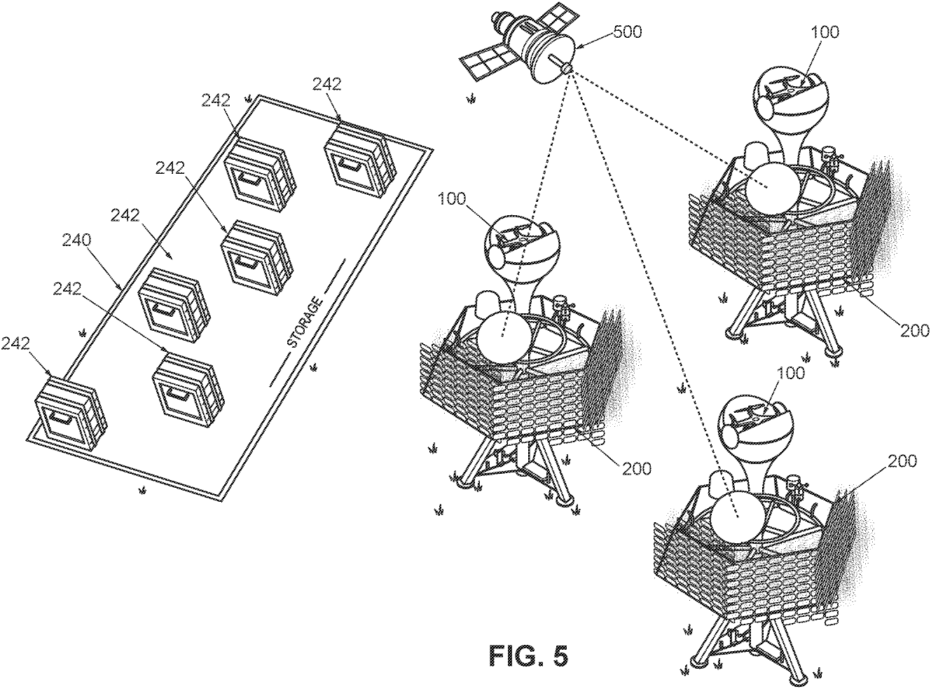

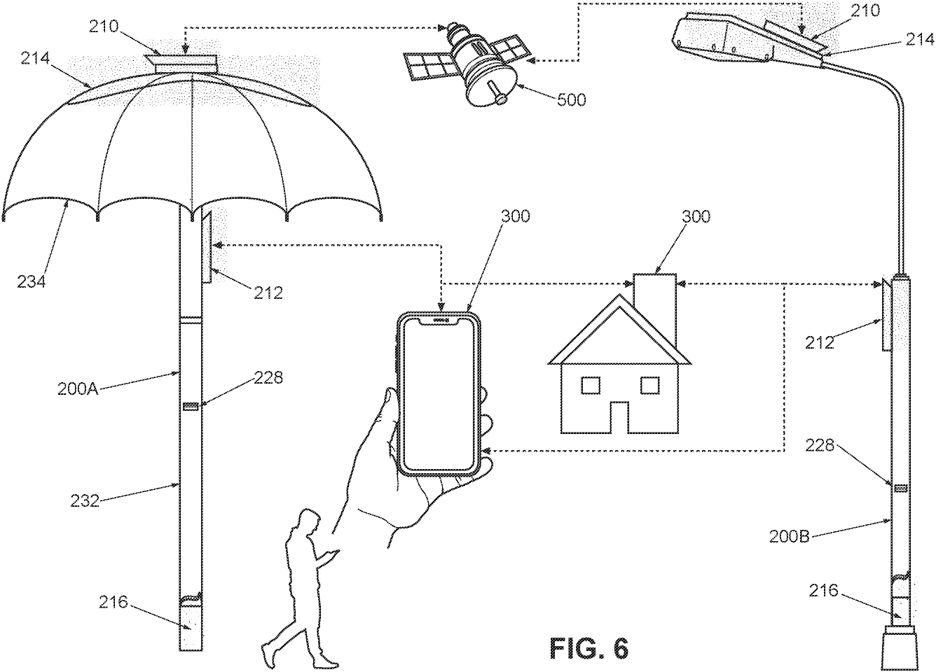

With regard to certain relay stations being located on land, FIGS. 5-6 illustrate exemplary land-based relay stations 200 having components illustrated in FIG. 3. Land-based relay stations can be configured for connection to any stationary or mobile structure or vehicle. For example, the various components of the land-based relay station 200 are individually, or via an enclosure, configured for connection to a rigid surface and protection from surrounding elements. Contemplated integrations and connections include, without limitation, to street lamps, street lights, telephone or power line poles, buoys, ski-lift poles or towers, structures of a stadium, structures of a resort or theme park, public transit vehicles or systems, military vehicles or systems, structures of or connected to a building or dwelling, naturally occurring structures such as trees or rocks, or any other structure, outdoor or indoor, natural or man-made. Contemplated integrations and connections further include, without limitation, to items that can be carried by a person such as, for example, umbrellas and backpacks.

Certain land-based relay stations, such as, for example, the land-based relay station 200 illustrated in FIG. 5, are configured to function as bases, hubs, nests, docks, moors and the like for the vehicles of the present invention. This aspect of the present invention will be described in greater detail below. Other land-based relay stations, such as, for example, the land-based relay stations 200A,200B illustrated in FIG. 6, are configured without such functionality.

While not shown, each relay station includes a GPS for knowing and determining its position and positions of other GPS equipped devices in real space, and determining directions and lines of travel to travel from one position to another.

It should be understood that land-based relay stations having any combination or permutation of one or more of the described components or functionalities are contemplated by the present invention.

With regard to mobile land-based relay stations, FIG. 6 illustrates a relay station in the form of an umbrella 200A. The umbrella relay station 200A can be either a stationary umbrella with a base or stand for support, or a handheld umbrella that is transportable. The illustrated umbrella 200A has the general structure of an umbrella including a shaft 232, a canopy 234 in operative surrounding connection of the shaft 232, and a stretcher mechanism (not shown) including a runner and ribs (not shown). The canopy 234 is extendable and collapsible via the stretcher mechanism in typical fashion. The illustrated umbrella 200A further includes an open and close button (not shown) in operative connection with the stretcher mechanism. Actuation of the button is operative to cause the stretcher mechanism to automatically move the canopy 234 between the extended (in use) position and collapsed (not in use) position. Other umbrella arrangements and components may be used in other embodiments. The illustrated umbrella 200A includes the relay station components indicated by the like numbered elements in FIG. 3.

With regard to stationary land-based relay stations, FIG. 6 also illustrates a relay station in the form of a lamppost 200B. The illustrated lamppost 200B includes the relay station components indicated by the like numbered elements in FIG. 3. In exemplary embodiments, the relay station may be connected to the lamppost 200B through a shear pin (not illustrated), that is designed to break upon heavy winds or storms. As such, when the lamppost 200B experiences heavy winds or storms, the shear pin would break, allowing the relay station to rotate freely to reduce damage thereto. Further, the rotation of the relay station may be connected or coupled to a generator which would generate additional energy as the relay station rotates in the wind or storm. However, the present inventive concept is not limited thereto.

### Relay Station Power

With regard to each relay station being configured to obtain power, each of the illustrated relay stations 200 operates on renewable energy. However, any power source can be used.

In preferred embodiments of the present invention, each relay station is further configured to obtain power from one or more of a solar panel, a wind energy generator, a movement energy generator, a wave energy generator, a geothermal energy generator, a nuclear power generator, an electrical power source, and a battery.

Each of the illustrated relay stations 200 includes a processor 202, a circuit 204, a memory 206, a modem 208, and a router 212, as well as a photovoltaic system or solar panel system 214 and at least one battery 216. The solar panel system 214 is comprised of multiple solar panels disposed on an outer surface of the relay station 200 in an arrangement operative to receive as much solar radiation as possible. The solar panel system 214 includes in operative connection therewith the necessary components, for example, combiners and inverters, in order to facilitate the conversion of the solar radiation from direct current (DC) electrical current to alternating current (AC) electrical current. For example, the illustrated solar panel system 214 is comprised of 100 watt, 12-volt solar panels.

The solar panel system 214 is in operative connection with the processor 202 and the battery 216 via the circuit 204. The processor 202 is operative to cause the battery 216 to store the electrical energy converted from solar radiation and is operative to cause power to be supplied via the circuit 204 to the various components of the relay station 200 when power from the solar panel system 214 is not available.

The processor 202 is in operative connection with the battery 216 and the solar panel system 214 via the circuit 204. Responsive to processor readable instructions included in the memory 206, the processor 202 is operative to cause the power source provided to the components of the relay station 200 to be changed between power supplied by the battery 216 and power supplied by the solar panel system 214. For example, the processor 202 is operative to cause a switch from power from the solar panel system 214 to power from the battery 202 at a specific time of day, or in response to a solar radiation sensor 218 that is operative to make a determination that available solar radiation is below a certain threshold in which solar powering is no longer feasible. Further, for example, the processor 202 is operative to cause a switch from power from the battery 202 to power from the solar panel system 214 at a specific time of day, or in response to the solar radiation sensor 218 that is also operative to make a determination that enough solar radiation is available.

The processor 202 is operative to switch from power from the battery 216 to power from the solar panel system 214 when a battery charge sensor 220 determines that available battery power is below a certain threshold. The processor 202 is also operative to cause the electrical energy received from the solar panel system 214 to be divided between charging the battery 216 and providing power to the relay station 200. For example, the illustrated battery 216 comprises a 12-volt, high storage, low weight battery. The relay station 200 includes a backup or emergency battery for situations in which the battery 216 does not have sufficient charge to operate in instances of insufficient solar radiation, or when the battery 216 otherwise fails to operate. Other battery configurations also can be used.

With regard to the umbrella relay station 200A illustrated in FIG. 6, the solar panel system 214 includes solar panels located on the outer surface of the canopy 234 to maximize their exposure to the sun. The solar panels can be rigid or flexible, and/or be in the form of narrow strips, and do not impede the opening and closing of the canopy 234. In addition, the processor 202, circuit 204, modem 208, memory 206 are located in the shaft 232.

With regard to the lamppost relay station 200B illustrated in FIG. 6, the solar panel system 214 includes solar panels located on a top surface of the relay station 200B to maximize their exposure to the sun. In addition, the processor 202, circuit 204, modem 208, memory 206 are located in the post.

With regard to other renewable energy sources for relay stations, certain instances of relay stations of the present invention can include one or more movement-based energy generators. For example, as illustrated in FIGS. 4-6, the land-based relay stations 200 and water-based relay station 200 each include a wind energy generator 224. Further for example, as illustrated in FIG. 4, the water-based relay station 200 includes a wave energy generator 226. For example, the wave energy generator 226 operates a pulley-based crank generator used as an external float and weight.

With regard to form factor optimization for the relay stations, certain instances of relay stations of the present invention can include the battery 216 located in a base or bottom section of the relay station 200. For example, as illustrated in FIG. 4, the water-based relay station includes the battery 216 located in a base or bottom of a buoy for use as a counterweight or for other purposes. Further for example, as illustrated in FIG. 6, the umbrella relay station 200A includes the battery 216 located at the bottom of the shaft 232 for effective weight distribution. Further for example, as illustrated in FIG. 6, the lamppost relay station 200B includes the battery 216 located at the bottom of the post for effective weight distribution.

### Relay Station Power Transfer to Devices

With regard to the relay stations being configured to provide power to other devices, FIG. 3 illustrates a schematic diagram of an exemplary relay station 200 of the present invention, FIG. 4 illustrates an exemplary water-based relay station 200 having components illustrated in FIG. 3, and FIGS. 5-6 illustrate exemplary land-based relay stations 200 having components illustrated in FIG. 3.

In preferred embodiments of the present invention, at least one relay station is configured to make at least a portion of the obtained power available through a port on the relay station.

Each of the illustrated relay stations 200 includes at least one charging port 228 and/or at least one charging pad 230. The illustrated charging pad 230 is an induction charging pad 230. The battery 216 of the relay station 200 is configured to provide power to the charging port 228 and/or charging pad 230 for charging devices connected thereto, such as, for example, laptop computers, tablets, mobiles phones, generators, light sources, etc. Certain relay stations can include a rack or other structure that positions the devices optimally for charging via the charging port 228 and/or charging pad 230. Accordingly, persons may place an electronic device (e.g., electronic devices 300 discussed elsewhere herein) in operative contacting relation with the charging port 228 and/or charging pad 230 in order to charge the electronic device.

### Relay Stations as Vehicle Nests

With regard to use of the relay stations with the vehicles of the present invention, certain relay stations of the present invention are configured to function as bases, hubs, nests, docks, moors and the like for the vehicles. However, it is contemplated by the present invention that the relay stations can be configured to so function for any type of vehicle or device. In certain embodiments, such relay stations can include partially enclosed docking stations for docking and protection of air-based drones during inclement weather. Further in certain embodiments, such relay stations can include latching or other securing mechanisms to temporarily fix the drones or otherwise maintain the drones in a stationary position.

### Relay Station Power Transfer to Vehicles

With regard to the relay stations being configured to provide power to the vehicles, FIG. 3 illustrates a schematic diagram of an exemplary relay station 200 of the present invention, FIG. 4 illustrates an exemplary land-based relay station 200 having components illustrated in FIG. 3, FIG. 5 illustrates an exemplary water-based relay station 200 having components illustrated in FIG. 3, and FIG. 1 illustrates an exemplary vehicle 100 of the present invention.

In preferred embodiments of the present invention, each of the relay stations configured to provide power to the vehicles includes at least one port at which each of the vehicles can dock, and is further configured to provide at least a portion of the obtained power at the at least one port to any one of the vehicles when docked at the at least one port.

As discussed above, each of the relay stations 200 illustrated in FIGS. 4-5 include at least one charging port 228 and/or at least one charging pad 230. The illustrated charging pad 230 is an induction charging pad 230. The battery 216 of the relay station 200 is configured to provide power to the charging port 228 and/or charging pad 230 for charging devices connected thereto, including the vehicles 100 of the present invention. Certain relay stations 200 can include a rack or other structure that positions the vehicles 100 optimally for charging via the charging port 228 or charging pad 230.

Correspondingly, each of the illustrated vehicles 100 includes a charging connection 128 compatible with the charging port 228 and/or an induction charging device 130 compatible with the charging pad 230. Accordingly, when a vehicle 110 is docked at the relay station 200 (e.g., situated on the induction charging pad 230 with the induction charging device 130 in charging communication with the induction charging pad 230; or at a position that enables or causes the charging connection 128 to connect to the charging port 228), the vehicle 100 can obtain power from the battery 216 of the relay station 200.

### Relay Station Internet Access and Relay to Devices

With regard to each relay station being configured to obtain an Internet connection, FIG. 2 illustrates an exemplary instance of this aspect of the present invention.

In preferred embodiments of the present invention, each relay station is configured to obtain an Internet connection from one or more of a satellite signal, a cellular signal, and a wired connection, and make the Internet connection available through the communication network via one or more of a cellular signal, a Wi-Fi signal, a Bluetooth signal, and a wired connection. Other wireless connections can also be used.

FIG. 2 illustrates a constellation of satellites 500. Contemplated embodiments of the present invention can use only one satellite, or any number of satellites in a constellation. In the illustrated embodiment, each satellite 500, and collectively the constellation of satellites, provides satellite-based Internet service by sending and receiving Internet service related data through one or more radio wave carriers 510. For example, the constellation is comprised of the Internet service satellite constellation provided by Starlink® or SpaceX®. However, it should be understood that the exemplary embodiments disclosed herein may be operatively configured to connect with or receive Internet service from any satellite of any Internet service satellite constellation or other Internet service satellite arrangement in, for example, low earth orbit, medium earth orbit, or geostationary orbit.

Further with regard to each relay station being configured to obtain an Internet connection, FIG. 3 illustrates a schematic diagram of an exemplary relay station 200 of the present invention, FIG. 4 illustrates an exemplary water-based relay station 200 having components illustrated in FIG. 3, and FIGS. 5-6 illustrate exemplary land-based relay stations 200 having components illustrated in FIG. 3.

In preferred embodiments, the relay station 200 is configured to receive and send Internet service related data from and to the satellites 500 in the constellation. In the illustrated embodiment, the relay station 200 includes a satellite antenna 210 and is configured to send and receive Internet service related data through the one or more radio wave carriers 510 using the satellite antenna 210. More particularly, the illustrated relay station 200 includes the processor 202, the circuit 204, the memory 206 and the modem 208, and the Internet service related data is caused to be communicated to and from the modem 208 by the processor 202 utilizing the circuit 204 and the memory 206. However, in alternative exemplary embodiments, the satellite antenna 210 additionally comprises suitable processors and other necessary components to convert the radio wave carriers 510 from the satellites 500 into one or more signals readable by the processor 202, and no modem is required. In other alternative exemplary embodiments, the radio wave carriers 510 received from the satellite 210 are already in a form readable by the processor 202, and no modem is required. For purposes herein, the processor 202 includes at least one of a processor, a microprocessor, and a CPU; associated circuitry; and a processor or computer readable medium or memory that includes instructions operative to cause the processor 202 to perform functions or operations. The processor 202 is preferably capable of performing any function for which there are processor readable instructions on the medium or memory. As can be appreciated, this system arrangement is exemplary, and in other embodiments, other arrangements may be used.

With regard to each relay station being configured to make the Internet connection available through the communication network, FIG. 3 illustrates a schematic diagram of an exemplary relay station 200 of the present invention, FIG. 4 illustrates an exemplary water-based relay station 200 having components illustrated in FIG. 3, and FIGS. 5-6 illustrate exemplary land-based relay stations 200 having components illustrated in FIG. 3.

In preferred embodiments, the relay station 200 is configured to distribute the received Internet service related data to other devices (including without limitation the vehicles, relay stations, and containers of the present invention, as well as third party devices) and send Internet service related data received from those other devices back to the relay station for delivery through the radio wave carriers 510 and/or otherwise through the communication network.

In the illustrated embodiments, the processor 202 is in operative connection with the satellite antenna 210 and the modem 208 and is operative to cause the modem 208 to convert the radio waver carrier 510 received by the satellite antenna 210 into a signal readable by the processor 202 responsive to processor readable instructions for the same stored in the memory 206. The processor 202 is further responsive to the memory 206 stored instructions to cause the router 212 to distribute the signal received from the modem 208 to a general area surrounding the relay station 200 using a wireless network. Accordingly, in the illustrated embodiment, the received Internet service related data can be distributed to devices in the general area surrounding the relay station 200.

Further in the illustrated embodiment, Internet service related data received from the devices through the wireless network is caused by the processor 202 to be communicated via the circuit 204 from the router 212 to the satellite antenna 210 for delivery through the radio wave carriers 510 and/or to other devices in the communication network.

In certain embodiments, the relay station 200 further comprises one or a series of signal extenders or repeaters, to increase the distribution area.

### Relay Station Control

With regard to control of the relay stations, in certain embodiments, one or more relay stations include at least one output device that provides information to users of the relay stations, and at least one user input device that enables users to command the relay stations. For example, the output device can include one or more of a video screen, a speaker, a light indicator, or other output device. For example, the input device can include one or more devices that enable user input via audio, a touch or contact to the screen, or a button of the input device, or other type of input. The output device and input device are in operative connection with one another to facilitate the commanding of the relay station by users and informing users of the results of the commanding.

For example, responsive to additional instructions stored in the memory 206, the processor 202 can causes the output device to output therethrough a streamed video, television station broadcast, map or GPS location (e.g., from a GPS in operative connection with the relay station), or a directional output that is operative to indicate to the user a direction to point the satellite antenna 210 to receive the strongest radio wave carrier transmission from the satellite 500. Alternatively, the processor 202 can cause an automated process to point the satellite antenna 210 in the direction of the strongest radio wave carrier transmission. The directional output can be received by the processor 202 via the Internet connection or via an electronic device 300 in operative connection with the wireless network or through a hardwired port (e.g., a USB port), or another wireless or wired connection. However, as can be appreciated, these are merely exemplary arrangements, and in other embodiments, other arrangements may be used.

It should be understood that operational control of the relay stations can also be implemented remotely through the communication network.

### Use of Relay Station Wireless Network by Devices

With regard to use of the relay station wireless network by devices, the wireless network generated by the relay station comprises a wireless local area network (WLAN) meeting necessary standards (e.g., Wi-Fi or Bluetooth), however, any wireless network may be used. Individuals within the distribution area are enabled to connect their electronic devices 300 to the wireless network, and therefore gain access to the Internet. Persons using electronic devices 300 within the distribution area may connect to the wireless network through typical selection of an available network via a user interface of the electronic device 300.

Once a person has selected the wireless network for use, the wireless network is operative to automatically cause a processor of the electronic device 300 to open a window or loading page with a specific uniform resource locator (URL) on a screen of the electronic device 300. However, the loading page may not automatically appear and may only appear after the person has launched an Internet browsing application on the electronic device 300. The loading page includes various selectable options to obtain usage rights to the wireless network as well as agree to required terms of use agreement. For example, the person may select via a user input to their electronic device 300 an option to merely use the wireless network for messaging or other written communication purposes, an option to use the wireless network for Internet browsing, or an option to use the wireless network for streaming, gaming or other high bandwidth activities.

Security options can be implemented to prevent unauthorized persons from gaining access to the wireless network. For example, the wireless network includes authentication security protocols to ensure wireless network security. The authentication security protocols used to secure the wireless network can include any available protocols for wireless network security. In addition, the wireless network can include options on the loading page selectable by the person via a user input to the electronic device 300 to protect the person’s personal information during use of the wireless network. For example, the options available to the person, and provided or made available on the loading page, may include an option to turn off sharing preferences on the electronic device, the option to connect to the wireless network through a virtual private network (VPN), an option to use a firewall, or an option to use antivirus software.

The wireless network can be used in connection with The Onion Router (Tor) software or similar software to encrypt and potentially extend the range of the communication network. Additionally, various types of encryption, performed by the processor 202, can be used to transmit data. Further, communications with at least one server can enable the memory 206 to be updated from time to time. Further, one or more components of the relay stations can be used in connection with other systems and software.

### Use of Relay Station Wireless Network by Vehicles

With regard to each vehicle being configured receive Internet service related data from each relay station, and send Internet service related data to each relay station, FIG. 1 illustrates an exemplary vehicle 100 of the present invention.

Each vehicle 100 is operable to access and use the wireless network to communicate with other vehicles, the relay stations, the containers, and third party devices. More particularly, each vehicle 100 has a processor, a circuit, a memory and a modem, and the Internet service related data is caused to be communicated to and from the modem by the processor utilizing the circuit and the memory.

Each vehicle 100 uses the communication network for accomplishing tasks and operations described herein, including, without limitation, making the communication network available to one or more third party devices in proximity to the vehicle 100.

In certain embodiments of the present invention, long range routers can be used to provide an Internet connection to devices and vehicles out of reach of the established local wireless network, which permits these devices and vehicles to use a further network provided by the long range routers to navigate back within range of an established local wireless network.

In certain embodiments of the present invention incorporating submersible vehicles, the relay stations may incorporate additional floats in operative wired or wireless connection to the relay stations that extend above water to provide a wireless connection to the submerged vehicle.

### Wireless Network Relay by Vehicles

With regard to each vehicle being configured to make the communication network available to one or more third party devices in proximity to the vehicle, FIG. 1 illustrates an exemplary vehicle 100 of the present invention.

In preferred embodiments of the present invention, each of one or more of the vehicles makes the communication network available to one or more third party devices in proximity to the vehicle.

Each vehicle 100 is configured to distribute the received Internet service related data to other devices (including without limitation other vehicles, relay stations, and containers of the present invention, as well as third party devices) and send Internet service related data received from those other devices back to the relay station 200 for delivery through the radio wave carriers 510 and/or otherwise through the communication network.

The processor of the vehicle 100 is further responsive to the memory stored instructions to cause the router to distribute the signal received from the modem to a general area surrounding the vehicle 100 using a wireless network. Accordingly, in the illustrated embodiment, the received Internet service related data can be distributed to devices (including without limitation other vehicles, relay stations, and containers of the present invention, as well as third party devices) in the general area surrounding the vehicle 100.

Further in the illustrated embodiment, Internet service related data received from the devices through the wireless network is caused by the processor to be communicated via the circuit from the router for delivery to other devices in the communication network.

Third party devices, such as for example, electronic devices 300 used by persons, can connect to the wireless network provided by the vehicles 100 to obtain Internet access and use the communication network, similar to the manner in which the electronic devices 300 can connect to the wireless network provided by the relay stations 200.

### Vehicles Establishing Communication Pathways

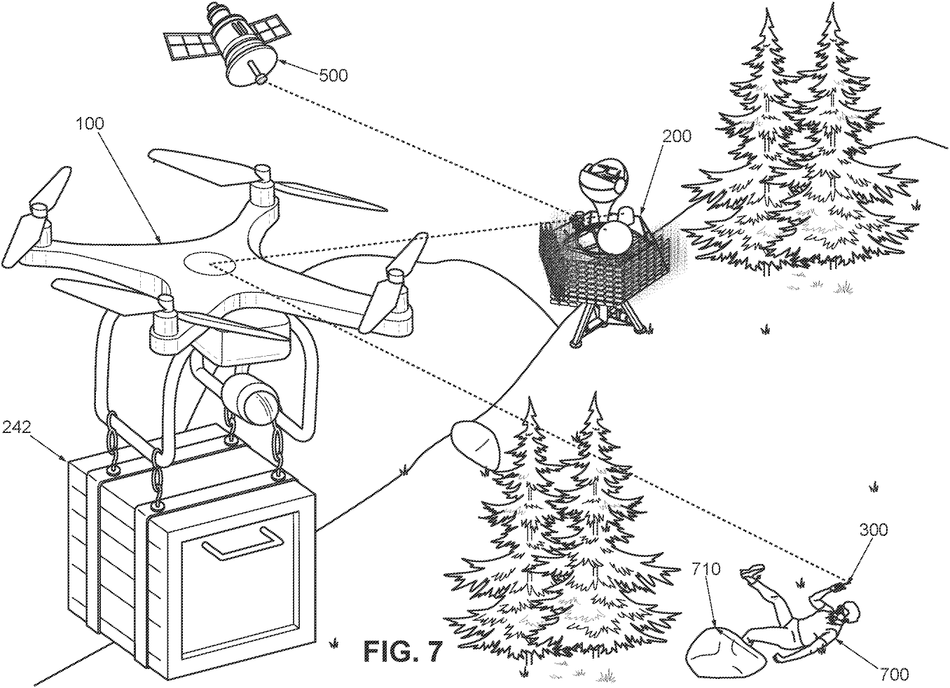

With regard to use of the communication network to conduct remote operations, FIGS. 7-11, illustrate preferred use cases of the present invention.

In preferred embodiments of the present invention, at least two of the vehicles maintain a communication pathway from one of the relay stations through a first of the at least two of the vehicles and through to a second of the at least two of the vehicles, the second of the at least two of the vehicles making the communication network available through the communication pathway to one of the third party devices, the one of the third party devices being in a remote area in proximity to the second of the at least two of the vehicles.

More particularly, a preferred use case of the illustrated embodiment is to use the above described capabilities of the vehicles 100 and relay stations 200 to extend the reach of the communication network, and accordingly the availability of the Internet access provided thereby, to remote areas.

For example, a plurality of vehicles 100 spaced from one another can establish a communication pathway through the vehicles 100 extending from the least remotely positioned vehicle to the most remotely positioned vehicle, so as to provide Internet access to the geographic area occupied by the most remotely positioned vehicle via the wireless network generated by the most remotely positioned vehicle. The communication pathway extends all the way back through the chain of vehicles to the least remotely positioned vehicle and obtains its Internet connection though a wireless network generated by a relay station 200 near the least remotely positioned vehicle. The wireless network generated by a relay station 200 provides Internet access by way of the relay station’s connection to the constellation of satellites 500.

By establishing one or more such communication pathways, the present invention can be useful for providing services and conducting remote operations that utilize the communication pathways. Several non-limiting examples of such services and remote operations are described later below and with further reference to FIGS. 7-11.

### Containers for Remote Operations

With regard to conducting remote operations, FIG. 1 illustrates an exemplary vehicle 100 of the present invention, FIG. 2 illustrates a plurality of relay stations 200 of the present invention positioned at respective locations on Earth. FIG. 3 illustrates a schematic diagram of an exemplary relay station 200 of the present invention. FIG. 4 illustrates an exemplary land-based relay station 200 of the present invention, and FIG. 5 illustrates an exemplary water-based relay station 200 of the present invention.

In preferred embodiments, the system of the present invention comprises a plurality of containers at the configured relay stations and configured for transport by the vehicles.

Certain remote operations can be accomplished, or their accomplishment can be assisted, by apparatus that would need to be delivered to the remote area in order to be useful. Accordingly, the present invention provides for the transport of apparatus to and from remote areas using the components and functionalities described above.

More particularly, certain relay stations are configured to store containers containing useful apparatus. The containers are configured for transport by the vehicles. That is, the vehicles can transport the containers to and from desired destinations. Exemplary relay stations 200 at which containers are stored include the relay stations illustrated in FIGS. 4 and 5.

More particularly, with references to FIGS. 1, and 3-5, each of the illustrated relay stations 200 includes a storage bay 240 for storing a plurality of containers 242. Each container 242 has at least one feature useful for facilitate the container 242 being transported by the vehicles 100. Correspondingly, each vehicle 100 has at least one feature useful for holding each container 242.

Each vehicle 100 is configured to navigate to a storage bay 240, capture and hold a container 242, and carry the container 242 with the vehicle 100 to a desired destination. Further, each vehicle 100 is configured to carry the container 242 with the vehicle 100 back from a desired destination, navigate to a storage bay 240, and place container 242 in a designated container storage location.

In preferred embodiments of the present invention, the vehicles, stations, and containers maintain a connection to a communication network through which they communicate with one another and with other devices connected to the network.

Accordingly, each container 242 is able to establish and maintain a connection to the communication network and communicate with other devices connected to the communication network. More particularly, each container 242 has a processor, a circuit, a memory, a modem, an antenna, a router and a battery in operative communication with one another to effect communication through the communication network. While not shown, each container includes a GPS for knowing and determining its position and positions of other GPS equipped devices in real space, and determining directions and lines of travel to travel from one position to another.

In preferred embodiments of the present invention, each container includes apparatus for use in a respective activity needed to complete one or more of the remote operations.

Further in preferred embodiments of the present invention, the activity is one or more of providing sustenance, providing shelter, providing medical care, alerting an emergency responder, providing rescue, providing protection, repelling an attack, launching an attack, fighting a natural disaster, delivering an item, and providing a service.

Accordingly, each container 242 includes apparatus for use in a respective activity needed to complete a type of remote operation. For example, the types of remote operations to which the apparatus are relevant includes those listed above and others.

For example, apparatus for use in providing sustenance can include food and water. For example, apparatus for use in providing shelter can include materials for building a tent, structure, or other enclosure. For example, apparatus for use in providing medical care can include medicine and bandages. For example, apparatus for use in alerting an emergency responder can include flares, sirens, and radios. For example, apparatus for use in providing rescue can include inflatable rafts, rope ladders, and life vests. For example, apparatus for use in providing protection can include raincoats, winter coats, gloves and helmets. For example, apparatus for use in repelling an attack can include defensive weapons, shields, and armor. For example, apparatus for use in launching an attack can include offensive weapons and armor. For example, apparatus for use in fighting a natural disaster can include water, fire retardant, and life vests. For example, apparatus for use in delivering an item can include the item itself, temperature maintenance bags (for food delivery), and packaging materials. For example, apparatus for use in providing a service can include items necessary for providing the service.

### Example Use Cases of the Present Inventive Concept

With regard to use of the present invention to conduct remote operations, FIGS. 7-11 illustrated preferred use cases of the present invention.

As discussed above, the present invention provides a system for conducting remote operations, comprising: a plurality of vehicles; a plurality of relay stations, one or more of which are configured to provide power to the vehicles; and a plurality of containers at the configured relay stations and configured for transport by the vehicles. In preferred embodiments, the vehicles, stations, and containers maintain a connection to a communication network through which they communicate with one another and with other devices connected to the network. In preferred embodiments, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network. In preferred embodiments, each container includes apparatus for use in a respective activity needed to complete one or more of the remote operations.

It can readily be understood that the capabilities provided by the present invention make possible and/or practical a variety of remote operations. Such remote operations can include, without limitation, the following:
(a) Providing wireless network and Internet access, including in remote areas, to people (e.g., pedestrians, recreationalists, military personnel, government agency personnel, adventurers in danger, sailors in distress, etc.), land, air and/or water vehicles (e.g., cars, campers, boats, ships, airplanes, helicopters, drones, emergency vehicles, military vehicles, electric cars, etc.), and robots, appliances, charging stations, and other autonomous or Internet of Things (IoT) objects or devices.
(b) Providing a wireless network establishing communication pathways for use as continuous “highway” for low altitude, land, and sea based transit by drones and other autonomous or remotely piloted vehicles.
(c) Providing drones to collect plastics, oil, or other debris present within bodies of water or other remote areas store for later disposal (e.g., the containers can be a receptable for the collection, transport, and removal of plastics, oil, or other debris).
(d) Providing communication and/or Internet access when the same provided by other systems or methods is no longer available or reliable (e.g., in instances of emergencies that involve power outages).
(e) By configuring the land-based and water-based relay stations and vehicles to “share” bandwidth by forming a “chain” of interconnected wireless networks, enabling communication via a “smart” Internet network when other Internet access sources fail.
(f) Providing Internet access and remote operations in disaster-prone areas (e.g., Haiti).
(g) Providing surveillance and other remote operations in areas susceptible to drug smuggling or other crimes.
(h) Deploying water-based relay stations and drones to monitor waterways and adjacent land locations that would benefit from heightened port security.
(i) Monitoring weather for forecasts and natural disaster tracking.
(k) Monitoring offshore oil operations, underwater fiber optic lines or other communications lines, as well as sea life or land-based wildlife.

### Remote Operation Use Cases

Referring now to FIG. 7, illustrated is a use case scenario in which a vehicle of the present invention delivers a container to an injured person stranded in a remote mountainous region.

In the illustrated use case scenario, a person 700 has been injured (e.g., a rock 710 has broken and trapped a leg of the person) in a remote mountainous region that has no cellular signal towers within range of the person’s mobile device 300. A relay station 200 of the present invention is situated outside the mountainous region out of range of the person’s mobile device 300. However, the relay station 200 has obtained Internet access from a satellite 500 and made the Internet access available to a drone 100 of the present invention that is able to fly close enough to the injured person’s mobile device 300 to extend the Internet access and communication network to the mobile device 300. Further, upon determining that the person needs medical care and rescue, the drone 100 has retrieved from the relay station 200 a container 242 that includes apparatus for use in providing such medical care and rescue (e.g., medicine, bandages, and flares). Further, the drone 100 has alerted emergency responders and transmitted to them the location of the person.

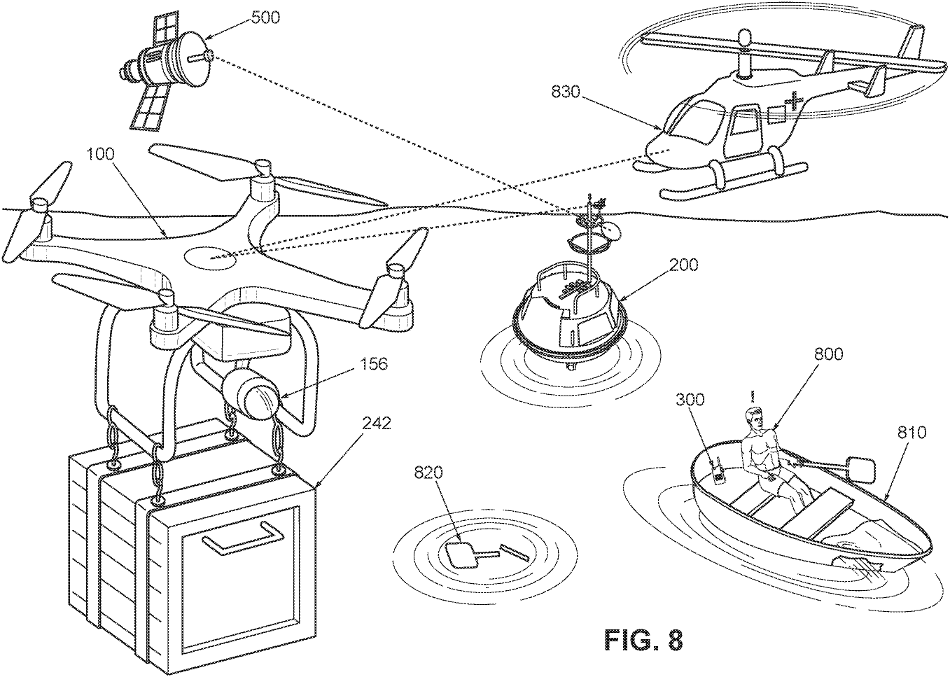

Referring now to FIG. 8, illustrated is a use case scenario in which a vehicle of the present invention delivers a container to a person in a damaged boat at a remote region of a large body of water.

In the illustrated use case scenario, a person 800 has been stranded in a remote region of a body of water. The person’s boat 810 and an oar 820 have been damaged, which prevents the person from transporting himself back to land. The remote region of the body of water has no cellular signal towers within range of the person’s mobile device 300, and the mobile device 300 has an exhausted battery. A relay station 200 of the present invention floating in the body of water has obtained Internet access from a satellite 500 and made the Internet access available to a drone 100 of the present invention. The drone 100 is able to fly close enough to the boat 810 to observe the situation with a camera 156 of the drone 100, and through the communication network alert emergency responders (e.g., in helicopter 830) to the situation and communicate to them the location of the boat 810. Further, the drone 100 has retrieved from the relay station 200 a container 242 that includes apparatus for use in repairing the boat 810 and charging the mobile device 300 (e.g., a patch kit and a mobile device charger).

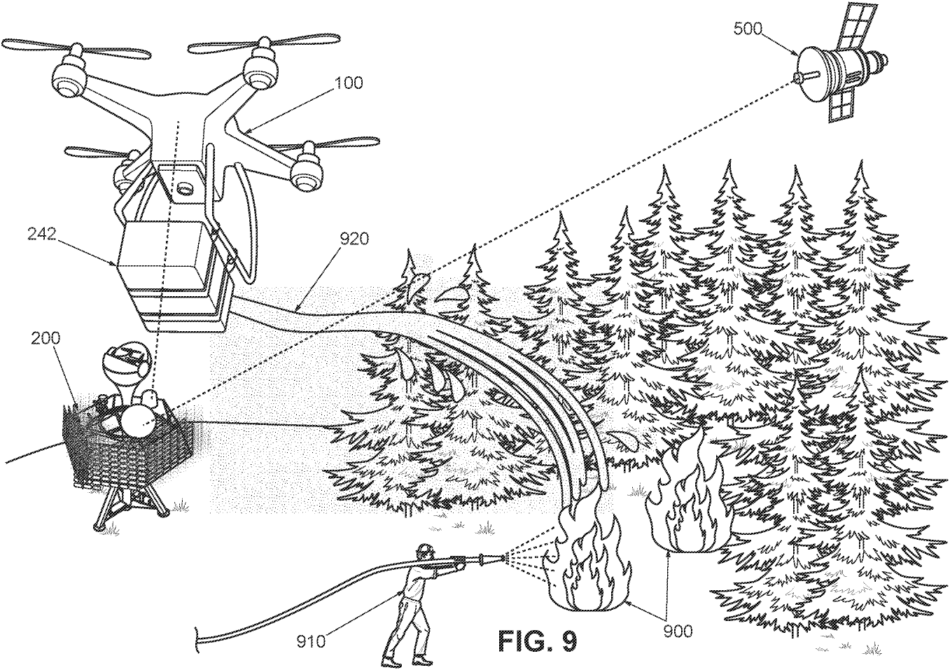

Referring now to FIG. 9, illustrated is a use case scenario in which a vehicle of the present invention is assisting in fighting a forest fire.

In the illustrated use case scenario, a fire 900 has started in a forested region. A drone 100 of the present invention has maintained communication with a relay station 200 of the present invention, which has obtained an Internet connection with a satellite 500. The drone 100 has been monitoring the forested region with a camera of the drone 100, and when the fire 900 started, the drone 100 noticed the incident and through the communication network altered emergency responders, who in turn dispatched a firefighter 910 to help extinguish the blaze. In addition, the drone 100 has retrieved from the relay station 200 a container 242 that includes fire repellant 920 and is operable to expel the fire repellant 920 onto the fire 900 to help extinguish the blaze.

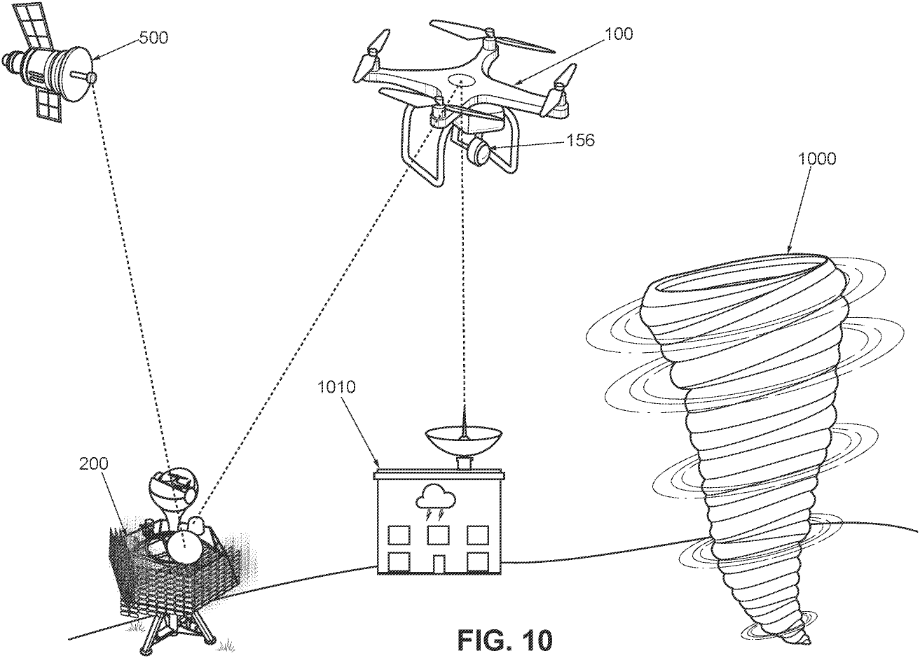

Referring now to FIG. 10, illustrated is a use case scenario in which a vehicle of the present invention is assisting in monitoring a tornado.

In the illustrated use case scenario, a tornado 1000 has formed in a remote area of the midwest United States. A drone 100 of the present invention has maintained communication with a relay station 200 of the present invention, which has obtained an Internet connection from a satellite 500. The drone 100 has been monitoring the remote area with a camera 156 of the drone 100, and when the tornado 1000 formed, the drone 100 noticed the formation and through the communication network altered a nearby weather station 1010, which in turn alerted nearby residents of the impending danger.

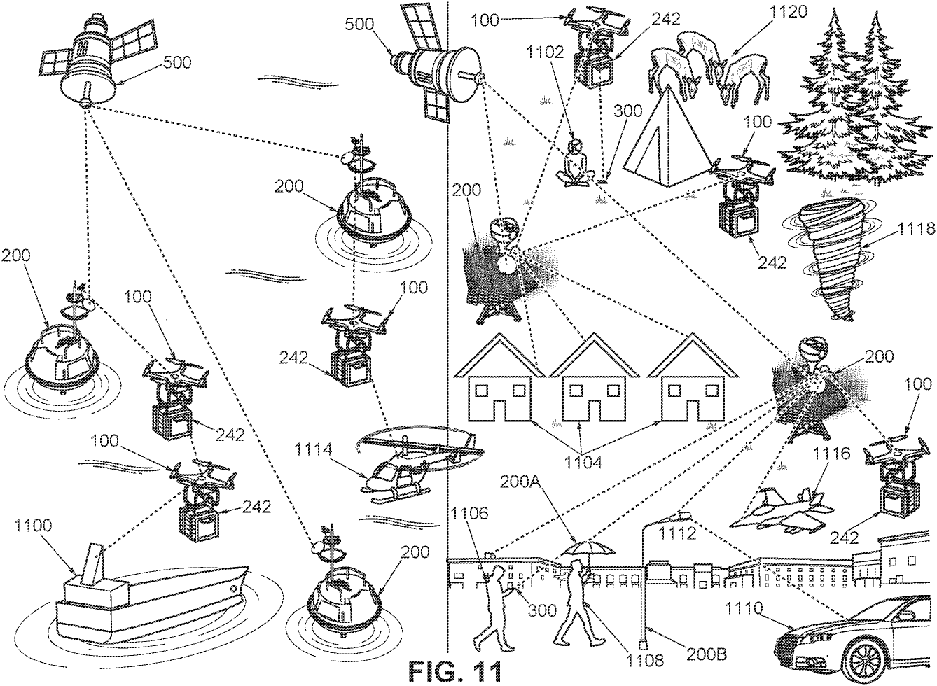

Referring again to FIG. 11, illustrated are additional use cases.

FIG. 11 illustrates water and land areas, the former (shown in the left side of FIG. 11) including water-based relay stations 200, the latter (shown in the right side of FIG. 11) including remote, rural and urban areas, with land-based relay stations 200, a lamppost relay station 200B, and a person carrying umbrella relay station 200A. The relay stations 200 obtain an Internet connection from an overhead constellation of satellites 500, and all form part of the described communication network of the present invention.

FIG. 11 further illustrate a ship 1100 in the water, a person 1102 camping in the remote area, homes 1104 in the rural area, and people 1106, 1108, a car 1110 and offices 1112 in the urban area. FIG. 11 further illustrate a medical helicopter 1114 over both land and water areas, and a military jet 1116 over the land area.

FIG. 11 further illustrates drones 100 of the present invention traveling and/or positioned among these elements 1100-1116 in proximity to the relay stations 200 to access the Internet and relay the Internet access to the elements 1100-1116 via wireless networks generated by the drones 100. Some of the drones are conducting remote operations, such as, for example, carrying containers 242 to deliver food (e.g., to the camper), monitoring a storm (e.g., tornado 1118), watching a herd of animals (e.g., deer 1120), alerting emergency responders (e.g., the helicopter 1114), and assisting the military (e.g., the jet 1116). All of these examples and more are made possible by the present invention.

### Monetizing Power and Internet Relay Use

Referring again to FIG. 11, illustrated are preferred use cases of the present invention. FIG. 11 includes use cases related to monetizing making power and Internet access available, including to remote areas.

In preferred embodiments, at least one of the Internet connection and the portion of the obtained power is made available based on one or more commercial transactions.

While the present invention contemplates monetizing any aspect of the capabilities of the present invention, the following are preferred examples that refer to the components and functionalities discussed herein.

The various exemplary wireless network usage and security options or features provided to the user for selection can be associated with a fee to be paid on a desired basis (e.g., per minute, per hour, per day, per month, per year, or offered on a license or subscription basis, or per usage basis). Each wireless network usage option alternatively or additionally can be selectable based on a specific data transfer rate (e.g., megabytes per second). For example, a user connecting to the wireless network merely for purposes of using relatively less data (e.g., messaging or Internet browsing) could pay a lower fee as compared to a user connecting to the wireless network for purposes of using relatively more data (e.g., streaming, gaming, video conferencing, or downloading large files). Alternatively or additionally, users desiring more stringent network security features could pay a higher fee than users requiring less stringent network security. Of course, these fee arrangements are exemplary, and as can be appreciated, any form of fee arrangement based on usage and needs may be used.

With regard receiving payment for such transactions, the wireless network loading page can include a payment options section. For example, the payment options section can include one or more payment options (e.g., credit card payment, PayPal®, Apple Pay®, Venmo®, Bitcoin, or any other form of payment). The payment section of the loading page can be a function of the wireless network and the processor 202 and can include one or more of the following steps: the user deciding on and selecting a wireless network usage and security option, the entity to be paid submitting a transaction, a payment gateway securely sending the transaction to the processor 202, the processor 202 verifying and approving the transaction, the user’s bank sending money to the processor 202, the processor 202 sending money to a bank of the entity to be paid, the processor 202 sending the approval or denial status of the transaction to the gateway, the merchant receiving an indication of approval or denial, and the entity to be paid receiving money for the selected wireless network usage option. However, these methods and processes for payment options is exemplary, and other payment option processes and methods may be used.

With regard to other methods of making payment, the functions of the loading page such as usage selection, security selections, payments methods, and any other options or preferences may be made available to users via an app on their electronic device 300. In certain embodiments, the user is permitted to use the wireless network for free to download the app and thereafter is charged for further wireless network usage. Additionally or alternatively, users can save their options and preferences on the app for future usage of the wireless network or a similarly provided wireless network. The app can be further operative to send the user advertisements, notifications, alerts, or other messages via the user’s electronic device 300. Of course, these app features are merely exemplary, and other app features may be used.

With regard to cost sharing arrangements for commercial use of the wireless network, in certain embodiments, numerous wireless network extenders can be used to make the wireless network available throughout a large area (e.g., neighborhood, restaurant or shopping district, port, dock area, or other large area where many people gather). Businesses or a group of individuals or households may agree to purchase and/or install an embodiment of the present invention with numerous wireless network extenders. In some of such arrangements, the various entities or individuals can agree to share the component and operational costs of the system. In some of such arrangements, the entities and individuals can offer the wireless network to their respective customers or a specified group of people (e.g., in a neighborhood arrangement) and can split the cost based on the desired wireless network usage to be made available to customers or others, or on actual usage basis. The loading page or app in such arrangements can additionally or alternatively include advertisement space for businesses or other attractions within the distribution area. The system owners may charge a fee for advertisement space on the loading page or app. The owners of the system may split the revenue generated from usage of the wireless network between one another in any manner agreed upon. Further, the provider or owner of the satellite constellation may be paid a percentage of the revenue in order to maintain, improve, and expand the satellite constellation. However, these arrangements for implementation of the system are exemplary, and other implementation arrangements may be used.

With regard to larger scale usage of embodiments of the present invention, one or more of the communication path “highways” discussed above can be established and for and used by commercial, government, or military entities for a fee. Alternatively or additionally, remote operations can be undertaken by, for, or on behalf of such entities for a fee. While government or military entities may need the remote operation capabilities of the system for higher stakes activities, commercial entities may need remote operation capabilities for implementing convenience services for customers. For example, embodiments of the present invention facilitate food or product deliveries and pickups at specific locations within the distribution area. In certain embodiments, one or more components can include or provide access to a GPS via the satellites 500 and to make the GPS available to users via their electronic devices 300. In certain embodiments, components of the system can include at least one camera, at least one motion sensor or other type of sensor, and at least one audible annunciator for projecting alarms of voice messages throughout the distribution area.

### Utilizing Excess Power and Internet Bandwidth

Referring again to FIG. 11, illustrated are preferred use cases of the present invention. FIG. 11 includes use cases related to utilizing excess power and Internet bandwith, including but not limiting to cryptocurrency mining, data capture, complex calculation assistance, and bulk data review assistance.

In preferred embodiments of the present invention, when the vehicles 100 and relay stations 200 are not in active use, they will generate surplus energy due to their energy generation components and storage, and their processors will be available for use. Therefore, the vehicles 100 and relay stations 200 can be used for cryptocurrency mining, data capture (e.g., mapping data), complex calculation assistance (e.g., complex math problems), and bulk data review assistance (e.g., astronomy data), which are energy or processor intensive tasks. These activities, and the surplus energy generation, can provide additional value and sources of revenue.

### Method Aspects

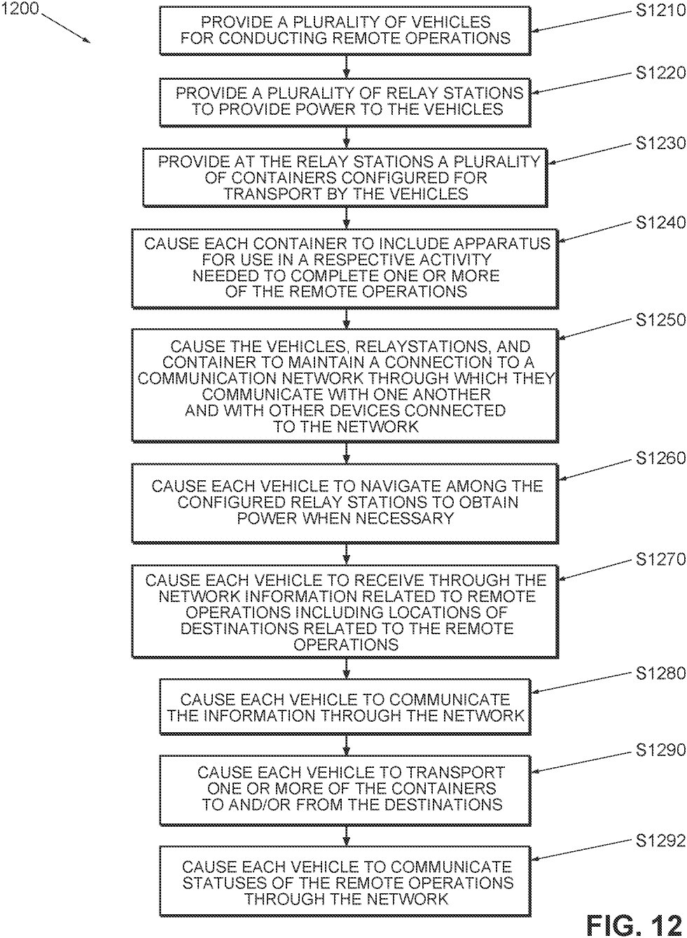

A preferred embodiment of a method of the present invention will be described in detail with reference to the elements illustrated in FIGS. 1-11 and discussed above, and with additional reference to FIG. 12. It should be understood that various embodiments of the method of the present invention can involve none or any number of any described aspect, and any permutation of described aspects.

More particularly, the present invention provides a method for conducting remote operations, comprising: providing a plurality of vehicles; providing a plurality of relay stations, one or more of which are configured to provide power to the vehicles; and providing a plurality of containers at the configured relay stations and configured for transport by the vehicles. In preferred embodiments, the vehicles, stations, and containers maintain a connection to a communication network through which they communicate with one another and with other devices connected to the network. In preferred embodiments, each vehicle is configured to navigate among the configured relay stations to obtain power when necessary, receive through the network information related to remote operations including locations of destinations related to the remote operations, communicate the information through the network, transport one or more of the containers to and/or from the destinations, and communicate statuses of the remote operations through the network. In preferred embodiments, each container includes apparatus for use in a respective activity needed to complete one or more of the remote operations.

Referring now to FIG. 12, illustrated is an exemplary method of the present invention. Elements of the exemplary system of the present invention described above are referenced in the illustrated method. However, any and all alternate elements of the exemplary system of the present invention described above and those in any and all described preferred and other embodiments are also contemplated for use in one or more embodiments of the method of the present invention.

FIG. 12 illustrates a preferred embodiment of the above described method. More particularly, the illustrated method 1200 comprises the steps of providing a plurality of vehicles for conducting remote operations (S1210); providing a plurality of relay stations to provide power to the vehicles (S1220); providing at the relay stations a plurality of containers configured for transport by the vehicles (S1230); causing each container to include apparatus for use in a respective activity needed to complete one or more of the remote operations (S1240); causing the vehicles, real stations, and container to maintain a connection to a communication network through which they communicate with one another and with other devices connected to the network (S1250); causing each vehicle to navigate among the configured relay stations to obtain power when necessary (S1260); causing each vehicle to receive through the network information related to remote operations including locations of destinations related to the remote operations (S1270); causing each vehicle to communicate the information through the network (S1280); causing each vehicle to transport one or more of the containers to and/or from the destinations (S1290); and causing each vehicle to communicate statuses of the remote operations through the network (S1292).

It should be understood that preferred embodiments of the method of the present invention can include more or fewer steps than those illustrated.

It should further be understood that as to each of the steps of the method, the components and functionalities of the various embodiments of the present invention discussed elsewhere herein related to such steps are examples of how such steps, substeps of such steps, and/or additional steps of the method are preferably or otherwise can be carried out by an actor undertaking methods of the present invention, whether directly by the actor or indirectly by the actor.

It should further be understood that any one or more of such steps, substeps, and/or additional steps of the method of the present invention can be practiced in any order, and in any combination, without departing from the scope of the present invention, and that the presented order and combination of steps is merely one of many preferred embodiments.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant’s general inventive concept.

1. A system for conducting remote operations, comprising:
a plurality of vehicles;
a plurality of relay stations, one or more of which are configured to provide power to the vehicles; and
a plurality of containers at the configured relay stations and configured for transport by the vehicles; wherein
the vehicles, stations, and containers maintain a connection to a communication network through which they communicate with one another and with other devices connected to the network;
each vehicle is configured to:
navigate among the configured relay stations to obtain power when necessary,
receive through the network information related to remote operations including locations of destinations related to the remote operations,
communicate the information through the network,
transport one or more of the containers to and/or from the destinations, and
communicate statuses of the remote operations through the network; and
each container includes apparatus for use in a respective activity needed to complete one or more of the remote operations.

2. The system of claim 1, wherein the activity is one or more of providing sustenance, providing shelter, providing medical care, alerting an emergency responder, providing rescue, providing protection, repelling an attack, launching an attack, fighting a natural disaster, delivering an item, and providing a service.

3. The system of claim 1, wherein the plurality of vehicles includes one or more of an aerial drone, a land drone, a water drone, a manned drone, an unmanned drone, a remotely piloted drone, a computer-piloted drone, and an autonomous drone.

4. The system of claim 3, wherein each of one or more of the vehicles makes the communication network available to one or more third party devices in proximity to the vehicle.

5. The system of claim 4, wherein at least two of the vehicles maintain a communication pathway from one of the relay stations through a first of the at least two of the vehicles and through to a second of the at least two of the vehicles, the second of the at least two of the vehicles making the communication network available through the communication pathway to one of the third party devices, the one of the third party devices being in a remote area in proximity to the second of the at least two of the vehicles.

6. The system of claim 1, wherein each relay station is configured to obtain an Internet connection from one or more of a satellite signal, a cellular signal, and a wired connection, and make the Internet connection available through the communication network via one or more of a cellular signal, a Wi-Fi signal, a Bluetooth signal, and a wired connection.

7. The system of claim 6, wherein each relay station is further configured to obtain power from one or more of a solar panel, a wind energy generator, a movement energy generator, a wave energy generator, a geothermal energy generator, a nuclear power generator, an electrical power source, and a battery.

8. The system of claim 7, wherein at least one relay station is further configured to make at least a portion of the obtained power available through a port on the relay station.

9. The system of claim 8, wherein each of the relay stations configured to provide power to the vehicles includes at least one port at which each of the vehicles can dock, and is further configured to provide at least a portion of the obtained power at the at least one port to any one of the vehicles when docked at the at least one port.

10. The system of claim 9, wherein at least one of the Internet connection and the portion of the obtained power is made available based on one or more commercial transactions.

11. A method of conducting remote operations, comprising:
providing a plurality of vehicles;
providing a plurality of relay stations, one or more of which are configured to provide power to the vehicles; and
providing a plurality of containers at the configured relay stations and configured for transport by the vehicles; wherein
the vehicles, stations, and containers maintain a connection to a communication network through which they communicate with one another and with other devices connected to the network;
each vehicle is configured to:
navigate among the configured relay stations to obtain power when necessary,
receive through the network information related to remote operations including locations of destinations related to the remote operations,
communicate the information through the network,
transport one or more of the containers to and/or from the destinations, and
communicate statuses of the remote operations through the network; and
each container includes apparatus for use in a respective activity needed to complete one or more of the remote operations.

12. The method of claim 11, wherein the activity is one or more of providing sustenance, providing shelter, providing medical care, alerting an emergency responder, providing rescue, providing protection, repelling an attack, launching an attack, fighting a natural disaster, delivering an item, and providing a service.

13. The method of claim 11, wherein the plurality of vehicles includes one or more of an aerial drone, a land drone, a water drone, a manned drone, an unmanned drone, a remotely piloted drone, a computer-piloted drone, and an autonomous drone.

14. The method of claim 13, wherein each of one or more of the vehicles makes the communication network available to one or more third party devices in proximity to the aerial vehicle.

15. The method of claim 14, wherein at least two of the vehicles maintain a communication pathway from one of the relay stations through a first of the at least two of the vehicles and through to a second of the at least two of aerial vehicles, the second of the at least two of the vehicles making the communication network available through the communication pathway to one of the third party devices, the one of the third party devices being in a remote area in proximity to the second of the at least two of the vehicles.

16. The method of claim 11, wherein each relay station is configured to obtain an Internet connection from one or more of a satellite signal, a cellular signal, and a wired connection, and make the Internet connection available through the communication network via one or more of a cellular signal, a Wi-Fi signal, a Bluetooth signal, and a wired connection.

17. The method of claim 16, wherein each relay station is further configured to obtain power from one or more of a solar panel, a wind energy generator, a wave energy generator, a geothermal energy generator, a nuclear power generator, an electrical power source, and a battery.

18. The method of claim 17, wherein at least one relay station is further configured to make at least a portion of the obtained power available through a port on the relay station.

19. The method of claim 18, wherein each of the relay stations configured to provide power to the vehicles includes at least one port at which each of the vehicles can dock, and is further configured to provide at least a portion of the obtained power at the at least one port to any one of the vehicles when docked at the at least one port.

20. The method of claim 19, wherein at least one of the Internet connection and the portion of the obtained power is made available based on one or more commercial transactions.
